(19) United States
(12) Patent Application Publication
(10) Pub. No.: US 2011/0199581 A1
(43) Pub. Date: Aug. 18, 2011

(54) OPTICAL PROJECTION SYSTEM AND METHOD FOR REDUCING UNESSENTIAL BEAMS FORMED THEREIN

(76) Inventors: Ruei-Bin JHANG, Hsinchu City (TW); Pei-Ching Liu, Hsinchu City (TW); Chien-Jung Huang, Hsinchu City (TW); S-Wei Chen, Hsinchu City (TW)

(21) Appl. No.: 13/023,954

(22) Filed: Feb. 9, 2011

(30) Foreign Application Priority Data
Feb. 12, 2010 (TW) 099104566

(51) Int. Cl. G03B 21/28

(52) U.S. Cl. 353/31; 353/38; 353/121

(57) ABSTRACT

An optical projection system includes a light source module, a field lens, a fly-eye lens, a light valve and a projection lens. The field lens is disposed on a propagation path of a light beam, where the light beam emitted from the light source module comprises a transmission light beam passing through the field lens and a reflection light beam reflected by the field lens. The fly-eye lens is disposed on the propagation path of the light beam and between the light source module and the field lens to homogenize the light beam, where the fly-eye lens includes a plurality of lens elements arranged in an array, the reflection light beam passes through the lens element via a transmissive region of the lens element, and at least one of an opaque structure, a light-diffusing structure and a light-deflecting structure is formed on the transmissive region.

### BACKGROUND OF THE INVENTION

a. Field of the Invention

The invention relates to an optical projection system and a method for reducing unessential beams formed in the optical projection system.

b. Description of the Related Art

FIG. 1 shows a schematic diagram of a conventional optical projection system. Referring to FIG. 1, the optical projection system 100 includes a light source 102, an illumination device 104, a field lens 106, a light valve 108, an imaging lens 112 with an aperture stop 116 and a screen 114. The light source 102 emits a light beam, and the light beam passes through the illumination device 104 and the field lens 106 in succession, reflected by the light valve 108, and then passes through the field lens 106 again. Finally, the light beam is projected onto the screen 114 by the imaging lens 112. However, when the light beam from the illumination device 104 impinges on the surface A1 of the field lens 106, part light beam is reflected by the surface A1 because the surface A1 fails to totally reflect or entirely absorb an incoming light beam. Accordingly, once the surface A1 is a convex surface, the part light beam reflected by the surface A1 diverges and then enters the aperture stop 116. The diverged light beam is focused by the field lens 106 to form an image of a spot near the light valve 108, thus forming the so-called ghost image G. FIG. 2 shows a schematic diagram illustrating a ghost image formed in a conventional optical projection system. Referring to FIG. 2, a ghost image G is formed on the periphery of a normal projection image N.

Hence, some designs are proposed to reduce ghost images formed in an optical projection system. For example, Taiwan patent no. 496998 discloses an optical projection system where a field lens is applied with a multi-layered anti-reflection coating to enhance the transmittance of green light, blue light, and red light is reflected by a dielectric coating to block ghost images. However, such design results in considerable fabrication costs. Further, Taiwan patent no. 457396 discloses a field lens whose surface curvature is optimized to deflect or diffuse ghost image beams towards the outside of an aperture stop. However, the change in the surface curvature of a field lens may affect light-transmitting angles to worsen the image quality.

### BRIEF SUMMARY OF THE INVENTION

The invention provides an optical projection system and a method for reducing unessential beams formed in the optical projection system. Other objects and advantages of the invention may be further illustrated by the technical features broadly embodied and described as follows.

In order to achieve one or a portion of or all of the objects or other objects, one embodiment of the invention provides an optical projection system. The optical projection system includes a light source module capable of emitting an illumination light beam, a field lens, a fly-eye lens, a light valve and a projection lens. The field lens is disposed on a propagation path of the illumination light beam, where the illumination light beam emitted from the light source module comprises a transmission light beam passing through the field lens and a reflection light beam reflected by the field lens. The fly-eye lens is disposed on the propagation path of the illumination light beam and between the light source module and the field lens to homogenize the light beam, where the fly-eye lens includes a plurality of lens elements arranged in an array, the reflection light beam passes through the lens element via a transmissive region of the lens element, and at least one of an opaque structure, a light-diffusing structure and a light-deflecting structure is formed on the transmissive region. The light valve is disposed on the propagation path of the illumination light beam and capable of transforming the illumination light beam into an image beam. The projection lens is disposed on the propagation path of the image beam.

In one embodiment, the opaque structure is a sand-blasting surface structure, the light-diffusing structure is a mist-surface structure, and the light-deflecting structure is a surface machinery micro structure.

In one embodiment, each of the lens elements has a long side and a short side, the length of the long side is L, the width of the short side is W, the length of a region with at least one of the opaque structure, the light-diffusing structure and the light-deflecting structure measured in a direction parallel to the long side is x, the width of the region measured in a direction parallel to the short side is y, and the length x and the width y satisfy the following condition:
0<x<L/3; and
0<y<W/3.

In one embodiment, at least one lens element without the opaque structure, the light-diffusing structure and the light-deflecting structure is disposed between two adjacent lens elements having at least one of the opaque structure, the light-diffusing structure and the light-deflecting structure.

In one embodiment, a color separation device is disposed between the light source module and the fly-eye lens. The color separation device has a first dichroic filter, a second dichroic filter and a third dichroic filter. A focus lens is disposed on the propagation path of the illumination light beam and between the color separation device and the field lens. A reflective mirror is disposed on the propagation path of the illumination light beam and between the fly-eye lens and the field lens.

According to another embodiment of the invention, a method for reducing unessential beams formed in an optical projection system, comprising the steps of tracing the routine of the unessential beams to recognize at least one lens element being passed by the unessential beams in an array of lens elements and to recognize a transmissive region formed on the lens element being passed by the unessential beams, where the unessential beams pass through the lens element via the transmissive region; and providing at least one of an opaque structure, a light-diffusing structure and a light-deflecting structure on the transmissive region.

The embodiment or the embodiments of the invention may have at least one of the following advantages. According to the above embodiments, one of the opaque structure, the light-diffusing structure or the light-deflecting structure formed on the transmissive region is allowed to block the unessential beams or reduce the optical energy of the unessential beams to a greater extent to suppress the formation of ghost images.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows a schematic diagram of a conventional optical projection system.

FIG. 2 shows a schematic diagram illustrating a ghost image formed in a conventional optical projection system.

FIG. 3 shows a schematic diagram of an optical projection system according to an embodiment of the invention.

FIG. 4 shows a schematic diagram of a fly-eye lens according to an embodiment of the invention.

FIG. 5 shows a schematic diagram of a fly-eye lens according to another embodiment of the invention, where an opaque structure or a light-diffusing structure is formed on the fly-eye lens.

FIG. 6 shows a schematic diagram of a fly-eye lens according to another embodiment of the invention, where an opaque structure or a light-diffusing structure is formed on the fly-eye lens.

FIG. 7 shows a schematic diagram illustrating the dimension of a fly-eye lens according to an embodiment of the invention.

FIG. 8 shows a schematic diagram of a fly-eye lens according to another embodiment of the invention, where a light-deflecting structure is formed on the fly-eye lens.

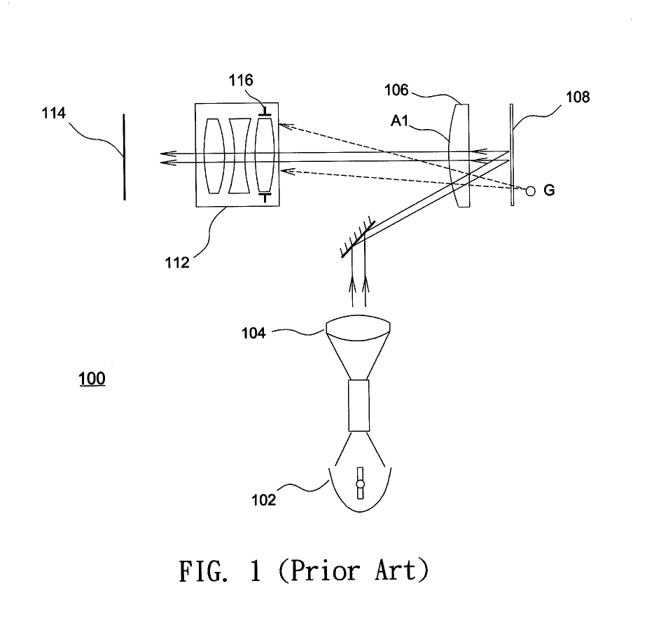

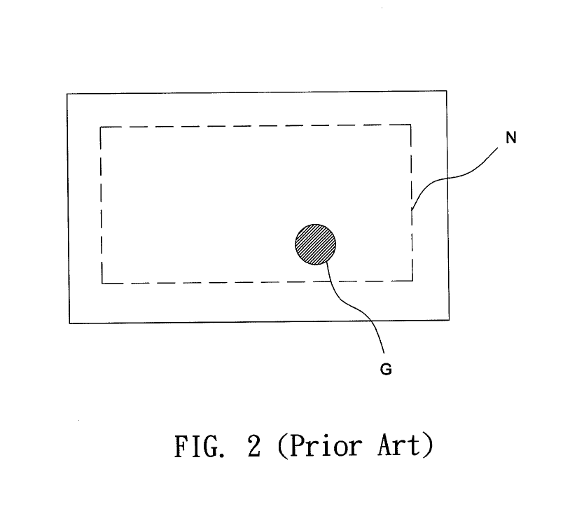

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

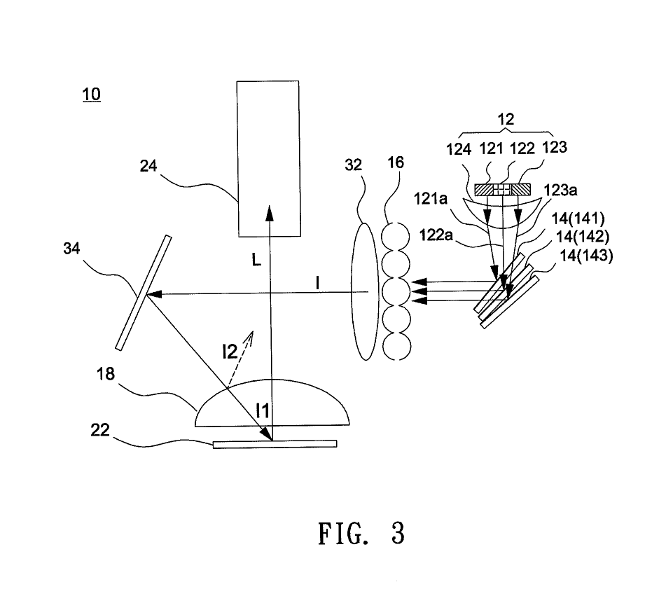

FIG. 3 shows a schematic diagram of an optical projection system according to an embodiment of the invention. Referring to FIG. 3, the optical projection system 10 includes a light source module 12, a color separation device 14, a fly-eye lens 16, a field lens 18, a light valve 22 and a projection lens 24. The light source module 12 is capable of emitting an illumination light beam I, and the fly-eye lens 16 is disposed on a propagation path of the illumination light beam I and between the light source module 12 and the field lens 18 to homogenize the light beam I. The field lens 18 is also disposed on a propagation path of the illumination light beam I. Since a typical optical coating fails to achieve one hundred percent transmittance, when the illumination light beam I is incident on the field lens 18, a major part of the illumination light beam I (transmission light beam I1) passes through the field lens 18 but a minor part of the illumination light beam I (reflection light beam or unessential beam) I2 is reflected by the field lens 18. The reflection light beam (unessential beam) I2 then travels through the projection lens 24 to form a ghost image (bright spot) on a screen (not shown). Replying on the specification structure of fly-eye lens 16 (as disclosed below), the unessential beam I2 reflected by the field lens 18 can mostly reduce so as to eliminate the ghost image on the screen. The light valve 22 is disposed on a propagation path of the illumination light beam I and capable of transforming the light beam I into an image beam L. In this embodiment, the light valve 22 may be a digital micro-mirror device (DMD). The projection lens 24 is disposed on a propagation path of the image beam L and capable of projecting the image beam L onto a screen to form a projection image.

In one embodiment, the light source module 12 includes a first light-emitting chip 121, a second light-emitting chip 122, a third light-emitting chip 123 and at least one condenser lens 124. The color separation device 14 is disposed between the light source module 12 and the fly-eye lens 16 and includes a first dichroic filter 141, a second dichroic filter 142 and a third dichroic filter 143. The first light-emitting chip 121 is capable of emitting a first light beam 121a, the second light-emitting chip 122 is capable of emitting a second light beam 122a, and the third light-emitting chip 123 is capable of emitting a third light beam 123a. Each of the first light-emitting chip 121, the second light-emitting chip 122 and the third light-emitting chip 123 may be an LED chip. Further, the first light beam 121a may be a red light beam, the second light beam 122a may be a green light beam, and the third light beam 123a may be a blue light beam. The first dichroic filter 141 is capable of reflecting the first light beam 121a, the second dichroic filter 142 is capable of reflecting the second light beam 122a, and the third dichroic filter 143 is capable of reflecting the third light beam 123a. After the first light beam 121a, the second light beam 122a and the third light beam 123a respectively leave the first dichroic filter 141, the second dichroic filter 142 and the third dichroic filter 143, they together form the illumination light beam I. A focus lens 32 is disposed on a propagation path of the illumination light beam I and between the color separation device 14 and the field lens 18. Besides, the optical projection system 10 may further include a reflective element 34 to improve the space utilization. In this embodiment, a reflective mirror 34 is disposed on a propagation path of the illumination light beam I and between the fly-eye lens 16 and the field lens 18. The reflective mirror 34 is allowed to change the propagation path of the illumination light beam I to improve the space utilization.

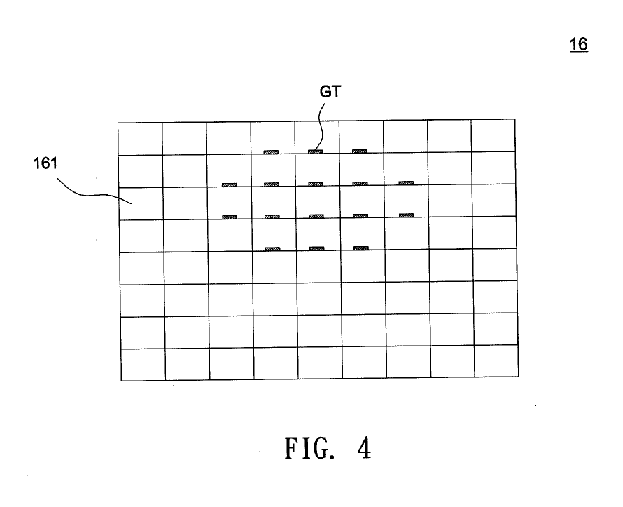

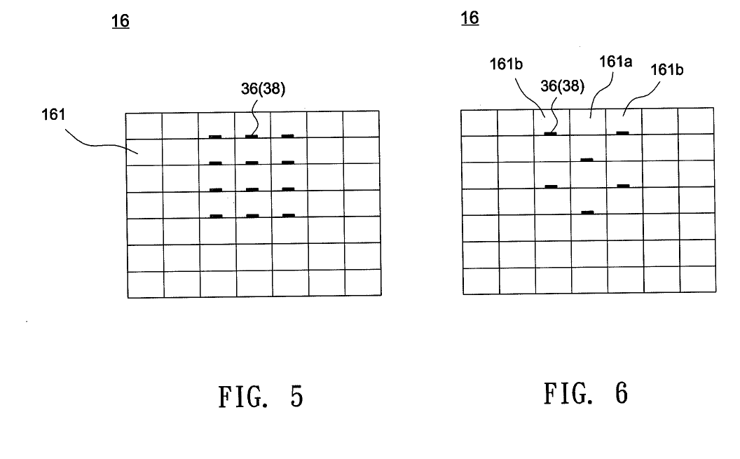

FIG. 4 shows a schematic diagram of a fly-eye lens 16 according to an embodiment of the invention. Referring to FIG. 4, the fly-eye lens 16 includes a plurality of lens elements 161 arranged in an array. As described earlier, the reflection light beam (unessential beam) I2 is reflected by the field lens 18 to form a ghost image. Hence, since the position of each dot of the ghost image is known, one can reversely trace the routine of the reflection light beam (unessential beam) I2 in the optical projection system 10 and thus recognize a transmissive region GT on each lens element 161, where the reflection light beam (unessential beam) I2 travels through the lens element 161 via the transmissive region GT. In other words, the reflection light beams (unessential beam) I2 passing through transmissive regions GT on different lens elements 161 together form ghost images. Typically, as seen in a light-spot distribution diagram of a fly-eye lens 16, it can be found each transmissive region GT where the unessential beam I2 passes is located on the periphery of a lens element 161. In one embodiment, after the transmissive region GT of a lens element 161 is recognized, an opaque structure 36 or a light-diffusing structure 38 is formed on the transmissive region GT, as shown in FIG. 5. In one embodiment, the opaque structure 36 may be a sand-blasting surface structure and the light-diffusing structure 38 may be a mist-surface structure. The opaque structure 36 or the light-diffusing structure 38 formed on the transmissive region GT is allowed to block the unessential beam I2 and reduce the optical energy of the unessential beam I2 to a greater extent to suppress the formation of ghost images. Further, since the opaque structure 36 or the light-diffusing structure 38 is formed on a tiny local region of a lens element 161, it only influences the brightness of a projection image to a small extent.

As shown in FIG. 5, the opaque structure 36 or the light-diffusing structure 38 is formed on each of the lens elements 161 where unessential beam I2 passes. However, this is not limited, and some of these lens elements 161 where unessential beam I2 passes may not be spread with the opaque structure 36 or the light-diffusing structure 38. For example, as shown in FIG. 6, in these lens elements 161 where unessential beam I2 passes, a lens element 161a without the opaque structure 36 or the light-diffusing structure 38 is disposed between two adjacent lens elements 161b with the opaque structures 36 or the light-diffusing structures 38. This may further decrease the influence on the overall brightness but still achieve the effect of reducing ghost images.

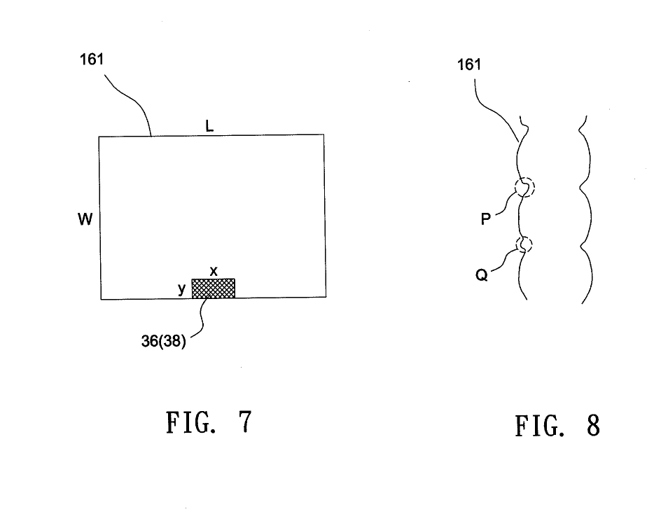

Referring to FIG. 7, in one embodiment, the lens element 161 is in the shape of a rectangle, for example, and has a long side and a short side. Assume the length of a long side is L, the width of the short side is W, the length of a region with the opaque structure 36 or the light-diffusing structure 38 measured in a direction parallel to the long side is x, and the width of a region with the opaque structure 36 or the light-diffusing structure 38 measured in a direction parallel to the short side is y, then a preferred range of the length x is set as 0<x<L/3, and a preferred range of the width y is set as 0<y<W/3. Further, the region where the opaque structures 36 or the light-diffusing structures 38 are spread is not limited to the shape of a rectangle, and the region may be in the shape of a circle, a polygon or other geometric figure.

As shown in FIG. 8, in an alternate embodiment, a surface machinery micro structure such as a notch P or a convex surface structure Q is formed on the transmissive region GT. The notch P or the convex surface structure Q is allowed to deflect the unessential beam I2 to change the propagation path of the unessential beam I2 and thus reduce the formation of ghost images.

According to the above embodiments, a method for reducing unessential beam in an optical projection system is provided as the following. First, the routine of a unessential beam I2 is traced to recognize which lens element 161 in an array of lens elements 161 the unessential beam I2 shall pass through and recognize a transmissive region GT formed on at least a part of the lens element 161, where the unessential beam I2 passes through the lens element 161 via the transmissive region GT. Then, at least one of an opaque structure, a light-diffusing structure and a light-deflecting structure is provided on the transmissive region GT to reduce the formation of ghost images.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. An optical projection system, comprising:
a light source module capable of emitting an illumination light beam;
a field lens disposed on a propagation path of the illumination light beam, wherein the illumination light beam emitted from the light source module comprises a transmission light beam passing through the field lens and a reflection light beam reflected by the field lens;
a fly-eye lens disposed on the propagation path of the illumination light beam and between the light source module and the field lens to homogenize the illumination light beam, wherein the fly-eye lens includes a plurality of lens elements arranged in an array, the reflection light beam passes through the lens element via a transmissive region of the lens element, and at least one of an opaque structure, a light-diffusing structure and a light-deflecting structure is formed on the transmissive region of the lens element;
a light valve disposed on the propagation path of the illumination light beam and capable of transforming the illumination light beam into an image beam; and
a projection lens disposed on the propagation path of the image beam.

2. The optical projection system as claimed in claim 1, wherein the light valve is a digital micro-mirror device.

3. The optical projection system as claimed in claim 1, wherein the opaque structure is a sand-blasting surface structure.

4. The optical projection system as claimed in claim 1, wherein the light-diffusing structure is a mist-surface structure.

5. The optical projection system as claimed in claim 1, wherein the light-deflecting structure is a surface machinery micro structure.

6. The optical projection system as claimed in claim 5, wherein the light-deflecting structure is a notch or a convex surface structure.

7. The optical projection system as claimed in claim 1, wherein each of the lens elements has a long side and a short side, the length of the long side is L, the width of the short side is W, the length of a region with at least one of the opaque structure, the light-diffusing structure and the light-deflecting structure measured in a direction parallel to the long side is x, the width of the region measured in a direction parallel to the short side is y, and the length x and the width y satisfy the following condition:
0<x<L/3; and
0<y<W/3.

8. The optical projection system as claimed in claim 1, wherein at least one lens element without the opaque structure, the light-diffusing structure and the light-deflecting structure is disposed between two adjacent lens elements having at least one of the opaque structure, the light-diffusing structure and the light-deflecting structure.

9. The optical projection system as claimed in claim 1, wherein the light source module includes a red LED chip, a green LED chip, a blue LED chip, and at least one condenser lens.

10. The optical projection system as claimed in claim 1, further comprising a color separation device disposed between the light source module and the fly-eye lens, and the color separation device having a first dichroic filter, a second dichroic filter and a third dichroic filter.

11. The optical projection system as claimed in claim 10, further comprising a focus lens disposed on the propagation path of the illumination light beam and between the color separation device and the field lens.

12. The optical projection system as claimed in claim 1, further comprising a reflective mirror disposed on the propagation path of the illumination light beam and between the fly-eye lens and the field lens.

13. A method for reducing unessential beams formed in an optical projection system, comprising the steps of:
tracing the routine of the unessential beams to recognize at least one lens element being passed by the unessential beams in an array of lens elements and to recognize a transmissive region formed on the lens element being passed by the unessential beams, wherein the unessential beams pass through the lens element via the transmissive region; and
providing at least one of an opaque structure, a light-diffusing structure and a light-deflecting structure on the transmissive region.

14. The method for reducing unessential beams as claimed in claim 13, wherein the unessential beams comprise reflection light beams reflected by a field lens.

15. The method for reducing unessential beams as claimed in claim 13, wherein the opaque structure is a sand-blasting surface structure.

16. The method for reducing unessential beams as claimed in claim 13, wherein the light-diffusing structure is a mist-surface structure.

17. The method for reducing unessential beams as claimed in claim 13, wherein the light-deflecting structure is a surface machinery micro structure.

18. The method for reducing unessential beams as claimed in claim 17, wherein the light-deflecting structure is a notch or a convex surface structure.

19. The method for reducing unessential beams as claimed in claim 13, wherein each of the lens elements has a long side and a short side, the length of the long side is L, the width of the short side is W, the length of a region with at least one of the opaque structure, the light-diffusing structure and the light-deflecting structure measured in a direction parallel to the long side is x, the width of the region measured in a direction parallel to the short side is y, and the length x and the width y satisfy the following condition:
0<x<L/3; and
0<y<W/3.
